(19) United States
(12) Patent Application Publication
(10) Pub. No.: US 2010/0054967 A1
(43) Pub. Date: Mar. 4, 2010

(54) High-Pressure Fuel Pump

(75) Inventor: Byung Soo LEE, Seoul (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/487,406

(22) Filed: Jun. 18, 2009

(30) Foreign Application Priority Data
Sep. 2, 2008 (KR) 10-2008-0086349

(51) Int. Cl. F04B 35/00; F16J 15/18

(52) U.S. Cl. 417/364; 92/165 R

(57) ABSTRACT

A high-pressure fuel pump includes a tappet assembly having a tappet for receiving a roller, and a fuel pump adaptor, the high-pressure fuel pump, wherein a reciprocal motion of the tappet assembly is guided by the fuel pump adaptor and a downward motion thereof is limited by the fuel pump adaptor, is provided.

### CROSS-REFERENCE TO RELATED APPLICATION

The present application claims priority to Korean Patent Application Number 10-2008-0086349 filed on Sep. 2, 2008, the entire contents of which application is incorporated herein for all purposes by this reference.

### BACKGROUND OF THE INVENTION

1. Field of the Invention

The present invention relates to a high-pressure fuel pump, and more particularly to a high-pressure fuel pump provided with a guide groove therein.

2. Description of Related Art

Generally, it has been disclosed that a high-pressure fuel pump for vehicles includes a cam rotating together with a camshaft that rotates by engine torque, a tappet assembly including a tappet and a roller moving upwardly by the rotation of the cam, and a return spring providing downward force to the tappet assembly.

The tappet assembly applied to such a high-pressure fuel pump is mounted at an interior circumference of a fuel pump adaptor having a cylindrical shape in a rolling-contact manner.

When the cam rotates, the tappet assembly including the tappet and the roller reciprocate while the roller contacts the cam.

Therefore, fuel for generating power of an internal combustion engine flows.

The tappet assembly should be assembled such that the roller has the same rotational direction as the cam so as to prevent friction or abrasion therebetween.

However, there is a difficulty with above-mentioned structure in that a worker must synchronize the rotational directions of the roller and the cam.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a high-pressure fuel pump having advantages of being able to guide reciprocation of a tappet provided to a fuel pump adaptor, and to allow installation work thereof to be easy and precise.

In an aspect of the present invention, a high-pressure fuel pump that is provided with a tappet assembly having a tappet for receiving a roller, and a fuel pump adaptor, includes a guide protrusion formed at an exterior circumference of the tappet along a longitudinal direction thereof, and a guide groove formed at an interior circumference of the fuel pump adaptor so as to slidably receive the guide protrusion therein and guide a reciprocal motion of the tappet along the fuel pump adaptor.

A shoulder may be formed at a lower end of the guide groove and configured and dimensioned to limit a downward movement of the guide protrusion so that the guide protrusion is not disengaged downwardly therefrom, wherein the shoulder is formed at a bottom portion of the fuel pump adaptor.

A vertical distance between a center of a cam and the shoulder may be between about 15 mm to about 32 mm, the cam being disposed at a bottom portion of the fuel pump adapter.

The guide protrusion may be spaced from a bottom surface of the tappet with a predetermined distance.

In another aspect of the present invention, a high-pressure fuel pump is provided with a tappet assembly having a tappet for receiving a roller, and a fuel pump adaptor, wherein a reciprocal motion of the tappet assembly is guided by the fuel pump adaptor and a downward motion thereof is limited by the fuel pump adaptor, wherein a guide protrusion is provided at an exterior circumference of the tappet assembly and engaged with a guide groove formed at an interior circumference of the fuel pump adaptor so as to guide a reciprocal motion of the tappet assembly along the fuel pump adaptor and wherein a shoulder is formed at a lower end of the guide groove and configured and dimensioned to limit a downward movement of the guide protrusion so that the guide protrusion is not disengaged downwardly therefrom.

The shoulder may be formed at a bottom portion of the fuel pump adaptor.

A vertical distance between a center of a cam and the shoulder may be between about 15 mm to about 32 mm, the cam being disposed at a bottom portion of the fuel pump adapter.

The guide protrusion may be spaced from a bottom surface of the tappet with a predetermined distance.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view showing an exemplary high-pressure fuel pump provided with a guide groove according to the present invention.

FIG. 2 is a cross-sectional view showing an exemplary high-pressure fuel pump provided with a guide groove according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

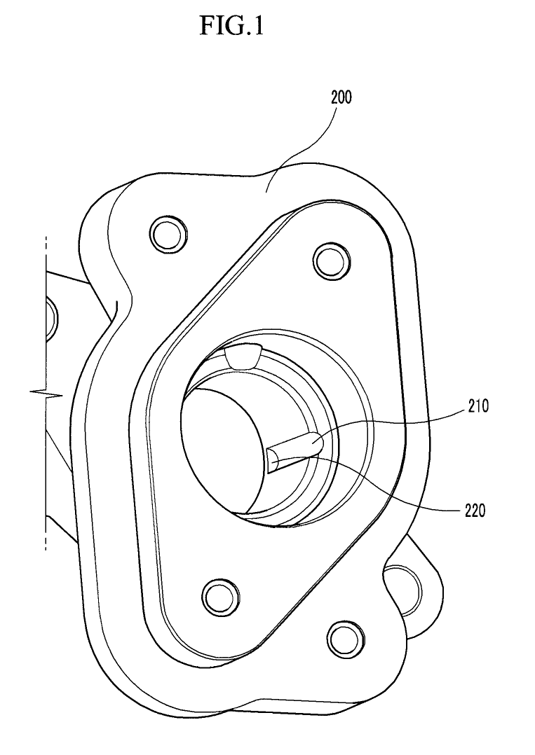

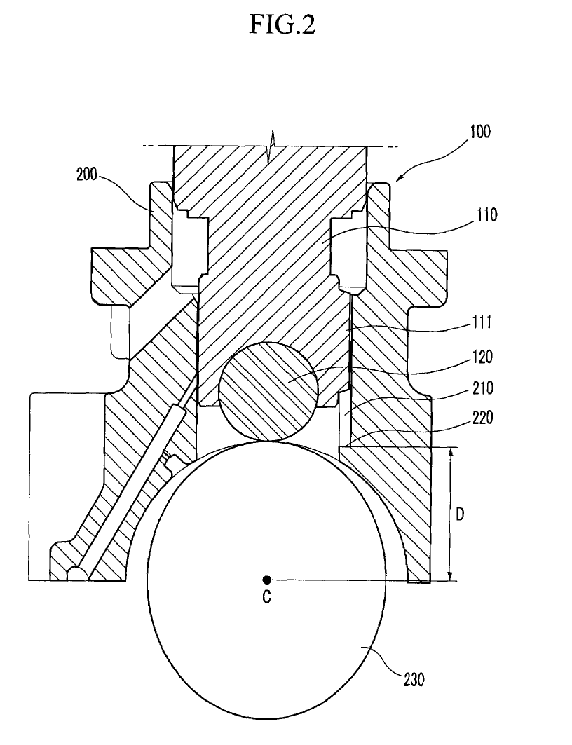

FIG. 1 is a perspective view showing an exemplary high-pressure fuel pump provided with a guide groove according to the present invention, and FIG. 2 is a cross-sectional view showing an exemplary high-pressure fuel pump provided with a guide groove according to the present invention.

As shown in FIG. 1 and FIG. 2, an exemplary high-pressure fuel pump according to the present invention includes a tappet assembly 100, a fuel pump adaptor 200, and a cam 230 that is simultaneously rotated with a camshaft.

The tappet assembly 100 as a conventional structure is provided with the cam 230 that is simultaneously rotated with the camshaft that is rotated by operation of an engine, and is provided with a tappet 110 that is reciprocated when the cam 230 rotates.

The tappet assembly 100 reciprocates as a result of a ramp of the rotating cam 230.

In addition, a tappet roller 120 is interposed between the tappet 110 and the cam 230 for ease of rotation.

Furthermore, a return spring may be provided so as to generate descent power of the tappet assembly 100.

The fuel pump adaptor 200 is provided so as to receive the tappet assembly therein such that the tappet assembly 100 slidably reciprocates.

A guide protrusion 111 is formed at an exterior circumference of the tappet 110 of the tappet assembly 100 that slides in the interior circumference of the fuel pump adaptor 200.

The guide protrusion 111 may be preferably formed to protrude in a length direction of the tappet 110.

According to various embodiments of the present invention, it is exemplarily described that a guide protrusion 111 is formed at an exterior circumference of the tappet 110, but the spirit of the present invention cannot be limited to this, and a plurality of guide protrusions 111 can be provided.

A guide groove 210 is formed at an interior circumference of the fuel pump adaptor 200 in a length direction thereof with a shape slidably receiving that of the guide protrusion 111.

Therefore, the tappet 110 is reciprocated and the guide protrusion 111 is guided at the same time in a reciprocating direction by the guide groove 210.

In addition, a catching dent or shoulder 220 may be provided at the bottom of the guide groove 210.

When the tappet assembly 100 is inserted into the fuel pump adaptor 200, the tappet assembly is prevented from being disengaged therefrom since the guide protrusion 111 is stopped by the catching dent 220.

In addition, when the guide protrusion 111 is snugly fitted into the guide groove 210, the rotation directions of the cam 230 and tappet roller 120 are synchronized. Thus, friction and abrasion therebetween are reduced, and installation work can be executed very quickly and precisely.

Meanwhile, as shown in FIG. 2, a vertical distance D between the point C at the center of the cam 230 may be determined by a person of ordinary skill in the art.

Considering performance, the type and capacity of the pump may be needed to determine the distance D.

Herein, the distance may be in a range of 15 mm to 32 mm, but the distance can be adjusted by experiment or experience.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A high-pressure fuel pump comprising:
a tappet assembly having a tappet for receiving a roller;
a fuel pump adaptor;
a guide protrusion formed at an exterior circumference of the tappet along a longitudinal direction thereof; and
a guide groove formed at an interior circumference of the fuel pump adaptor so as to slidably receive the guide protrusion therein and guide a reciprocal motion of the tappet along the fuel pump adaptor.

2. The high-pressure fuel pump of claim 1, wherein a shoulder is formed at a lower end of the guide groove and configured and dimensioned to limit a downward movement of the guide protrusion so that the guide protrusion is not disengaged downwardly therefrom.

3. The high-pressure fuel pump of claim 2, wherein the shoulder is formed at a bottom portion of the fuel pump adaptor.

4. The high-pressure fuel pump of claim 2, wherein a vertical distance between a center of a cam and the shoulder is between about 15 mm to about 32 mm, the cam being disposed at a bottom portion of the fuel pump adapter.

5. The high-pressure fuel pump of claim 1, wherein the guide protrusion is spaced from a bottom surface of the tappet with a predetermined distance.

6. A vehicle comprising the high-pressure fuel pump of claim 1.

7. A high-pressure fuel pump comprising:
a tappet assembly having a tappet for receiving a roller; and
a fuel pump adaptor;
wherein a reciprocal motion of the tappet assembly is guided by the fuel pump adaptor and a downward motion thereof is limited by the fuel pump adaptor.

8. The high-pressure fuel pump of claim 7, wherein a guide protrusion is provided at an exterior circumference of the tappet assembly and engaged with a guide groove formed at an interior circumference of the fuel pump adaptor so as to guide a reciprocal motion of the tappet assembly along the fuel pump adaptor.

9. The high-pressure fuel pump of claim 7, wherein a shoulder is formed at a lower end of the guide groove and configured and dimensioned to limit a downward movement of the guide protrusion so that the guide protrusion is not disengaged downwardly therefrom.

10. The high-pressure fuel pump of claim 9, wherein the shoulder is formed at a bottom portion of the fuel pump adaptor.

11. The high-pressure fuel pump of claim 7, wherein a vertical distance between a center of a cam and the shoulder is between about 15 mm to about 32 mm, the cam being disposed at a bottom portion of the fuel pump adapter.

12. The high-pressure fuel pump of claim 7, wherein the guide protrusion is spaced from a bottom surface of the tappet with a predetermined distance.

13. A vehicle comprising the high-pressure fuel pump of claim 7.
